(19) United States
(12) Patent Application Publication
(10) Pub. No.: US 2024/0223432 A1
(43) Pub. Date: Jul. 4, 2024

(54) METHODS, NETWORK NODE, WIRELESS DEVICE, MEDIA FOR TBS INDEX RANGE INTERPRETATION FOR 16-QAM IN DIFFERENT DEPLOYMENT MODES

(71) Applicant: Telefonaktiebolaget LM Ericsson (publ), Stockholm (SE)

(72) Inventors: Gerardo Agni MEDINA ACOSTA, Märsta (SE); Liping ZHANG, Beijing (CN); Jie CHEN, Beijing (CN)

(21) Appl. No.: 18/289,074

(22) PCT Filed: May 10, 2022
(86) PCT No.: PCT/EP2022/062659

§ 371 Date: Oct. 31, 2023

(30) Foreign Application Priority Data
May 11, 2021 (WO) PCT/CN2021/092992

(51) Int. Cl. H04L 27/34; H04L 1/00; H04L 27/26; H04W 72/232

(52) U.S. Cl. CPC H04L 27/34; H04L 1/0004; H04L 27/2602; H04W 72/232

(57) ABSTRACT

Methods, a UE, a network node, and computer readable storage media for TBS index range interpretation for 16-QAM in different deployment modes are disclosed. The method at the UE includes: receiving, from a network node, information including: a first indication of a deployment mode for communication, a second indication of use of 16-QAM, and a third indication of a range of TBS indices for 16-QAM and interpreting, based on said deployment mode, the range of TBS indices for 16-QAM as a range of TBS indices for 16-QAM in said deployment mode.

### CROSS REFERENCE TO RELATED APPLICATIONS

This application is a 35 U.S.C. § 371 national stage application of PCT International Application No. PCT/EP2022/062659 filed on May 10, 2022, which in turn claims foreign priority to International Patent Application No. PCT/CN2021/092992, filed on May 11, 2021, the disclosures and content of which are incorporated by reference herein in their entirety.

### TECHNICAL FIELD

The present disclosure relates to wireless communications, and in particular, to methods, a network node, a wireless device, computer readable storage media for transport block size (TBS) index range interpretation for 16-quadrature amplitude modulation (16-QAM) in different deployment modes.

### BACKGROUND

During the radio access network (RAN) plenary meeting #86 (RP-193264), a new Work Item (WI) entitled “Rel-17 enhancements for NB-IOT and LTE-MTC” was discussed. In the Work Item Description (WID), one of the objectives is described as follows:
Specify 16-quadurature amplitude modulation (QAM) for unicast in uplink (UL) and downlink (DL), including necessary changes to DL power allocation for narrowband physical downlink shared channel (NPDSCH) and DL TBS. This is to be specified without a new Narrowband Internet of Things (NB-IOT) User Equipment (UE) category. For DL, increase in maximum TBS of, e.g., 2× the third generation partnership project (3GPP) Release 16 (Rel-16) maximum, and soft buffer size may be specified by modifying at least existing Category NB2. For UL, the maximum TBS is not increased. [NB-IOT] [RAN1, RAN4]
   Extend the NB-IOT channel quality reporting based on the framework of Rel-14-16, to support 16-QAM in DL. [NB-IOT] [RAN2, RAN1, RAN4]
Specify signaling for neighbor cell measurements and corresponding measurement triggering before Radio Link Failure (RLF), to reduce the time taken to Radio Resource Control (RRC) reestablishment to another cell, without defining specific gaps. [NB-IOT] [RAN2, RAN4]

One key aspect towards the standardization of 16-QAM for NB-IOT consists in the design of the TBS/Modulation and Coding Scheme (MCS) Tables. For DL, the design of the TBS/MCS table has to take into account the different deployment modes in NB-IOT, which are “Stand-alone”, “Guard-band”, and “In-band” deployments.

Touching upon the TBS/MCS table design, the following agreements were reached for “Stand-alone” and “Guard-band” deployments:

### Agreement

Confirm the working assumption that the following TBS indices in Table 1 below are introduced for DL with modification underlined Bold:

TABLE 1
Transport block Size (TBS) for 16-QAM In Stand-Alone
and Guard-Band Deployments (I_TBS Indices 14~21)

| | I_{SF} | | | | | | | |
|---|---|---|---|---|---|---|---|---|
| I_{TBS} | 0 | 1 | 2 | 3 | 4 | 5 | 6 | 7 |
| 14 | 256 | 552 | 840 | 1128 | 1416 | 1736 | 2280 | 2856 |
| 15 | 280 | 600 | 904 | 1224 | 1544 | 1800 | 2472 | 3112 |
| 16 | [symbol] | 632 | 968 | 1288 | 1608 | 1928 | 2600 | 3240 |
| 17 | 336 | 696 | 1064 | 1416 | 1800 | 2152 | 2856 | 3624 |
| 18 | 376 | 776 | 1160 | 1544 | 1992 | 2344 | 3112 | 4008 |
| 19 | 408 | 840 | 1288 | 1736 | 2152 | 2600 | 3496 | 4264 |
| 20 | 440 | 904 | 1384 | 1864 | 2344 | 2792 | 3752 | 4584 |
| 21 | 488 | 1000 | 1480 | 1992 | 2472 | 2984 | 4008 | 4968 |

### Agreement

### Confirm the Working Assumption:

For “Stand-alone” and “Guard-band” deployments, the DL TBS entries between 14 (e.g., TBS of 2856 for I_SF=7) and 21 are used for 16-QAM.

On the other hand, the “In-band” deployment will be based on the TBS/MCS table design as for “Stand-alone” and “Guard-band” deployments, the only difference is that the “In-band deployment” will span from the I_TBS index 11 to 17 which are bolded in Table 2 below (re-using part of the TBS/MCS for quadrature phase shift keying (QPSK), i.e., TBS entries corresponding to I_TBS indices 11, 12, and 13) (c.f. Session notes for 8.9 (Rel-17 enhancements for NB-IOT and LTE-MTC), Ad-hoc chair (Samsung), 3GPP TSG RAN WG1 Meeting #104-e, e-Meeting, Jan. 25-Feb. 5, 2021, which is incorporated herein in its entirety by reference). The “In-band” deployment starts from an earlier I_TBS index due to that this deployment mode has less resource elements available for data which translates into a higher overhead leading to higher achievable code rates compared to other deployment modes.

TABLE 2
Transport block Size (TBS) for Both QPSK and 16-QAM In Stand-Alone, Guard-Band
and In-Band Deployments (All I_TBS Indices)

| Modulation | | I_{SF} | | | | | | | | |
|---|---|---|---|---|---|---|---|---|---|---|
| Scheme | I_{TBS} | 0 | 1 | 2 | 3 | 4 | 5 | 6 | 7 | |
| QPSK | 0 | 16 | 32 | 56 | 88 | 120 | 152 | 208 | 256 | QPSK |
| | 1 | 24 | 56 | 88 | 144 | 176 | 208 | 256 | 344 | In-band |
| | 2 | 32 | 72 | 144 | 176 | 208 | 256 | 328 | 424 | |
| | 3 | 40 | 104 | 176 | 208 | 256 | 328 | 440 | 568 | |
| | 4 | 56 | 120 | 208 | 256 | 328 | 408 | 552 | 680 | |
| | 5 | 72 | 144 | 224 | 328 | 424 | 504 | 680 | 872 | |
| | 6 | 88 | 176 | 256 | 392 | 504 | 600 | 808 | 1032 | |
| | 7 | 104 | 224 | 328 | 472 | 584 | 680 | 968 | 1224 | |
| | 8 | 120 | 256 | 392 | 536 | 680 | 808 | 1096 | 1352 | |
| | 9 | 136 | 296 | 456 | 616 | 776 | 936 | 1256 | 1544 | |
| | 10 | 144 | 328 | 504 | 680 | 872 | 1032 | 1384 | 1736 | |
| | 11 | 176 | 376 | 584 | 776 | 1000 | 1192 | 1608 | 2024 | 16- |
| | 12 | 208 | 440 | 680 | 904 | 1128 | 1352 | 1800 | 2280 | QAM |
| | 13 | 224 | 488 | 744 | 1032 | 1256 | 1544 | 2024 | 2536 | In-band |
| 16-QAM | 14 | 256 | 552 | 840 | 1128 | 1416 | 1736 | 2280 | 2856 | |
| Guard-band/ | 15 | 280 | 600 | 904 | 1224 | 1544 | 1800 | 2472 | 3112 | |
| Stand-alone | 16 | 296 | 632 | 968 | 1288 | 1608 | 1928 | 2600 | 3240 | |
| | 17 | 336 | 696 | 1064 | 1416 | 1800 | 2152 | 2856 | 3624 | |
| | 18 | 376 | 776 | 1160 | 1544 | 1992 | 2344 | 3112 | 4008 | |
| | 19 | 408 | 840 | 1288 | 1736 | 2152 | 2600 | 3496 | 4264 | |
| | 20 | 440 | 904 | 1384 | 1864 | 2344 | 2792 | 3752 | 4584 | |
| | 21 | 488 | 1000 | 1480 | 1992 | 2472 | 2984 | 4008 | 4968 | |

### Agreement

The following working assumption is confirmed with following modifications:
For “In-band” deployment, the DL TBS entries between 11 (e.g., TBS of 2024 for I_SF=7) and 17 are used for 16-QAM.

### SUMMARY

Some exemplary embodiments of the present disclosure advantageously provide methods, apparatuses, and media for TBS index range interpretation for 16-QAM in different deployment modes, which incorporate additional aspects that have not been incorporated yet into the options listed towards preparing the DCI design for 16-QAM in DL.

One or more embodiments of the present disclosure mainly focus on:
I_TBS index range interpretation for “Stand-alone or Guard-band or In-band deployment” from information about the corresponding deployment mode that can be obtained from system information (such as MIB-NB for anchor carriers, SystemInformationBlockType22-NB-r14 for non-anchor carriers) and/or UE specific configuration (such as DL-CarrierConfigDedicated-NB for non-anchor carriers)
I_TBS index range interpretation for “Stand-alone or Guard-band or In-band deployment” from DCI, such as two reserved states in the MCS field in DCI.

According to a first aspect of the present disclosure, a method at a UE is provided. The method includes: receiving, from a network node, information including: a first indication of a deployment mode for communication, a second indication of use of 16-QAM, and a third indication of a range of TBS indices for 16-QAM; and interpreting, based on said deployment mode, the range of TBS indices for 16-QAM as a range of TBS indices for 16-QAM in said deployment mode.

In an exemplary embodiment, the deployment mode includes one of: a Stand-alone deployment, a Guard-band deployment, and an In-band deployment.

In an exemplary embodiment, said interpreting the range of TBS indices for 16-QAM further includes: in a case where the first indication indicates the Stand-alone or Guard-band deployment, interpreting the range of TBS indices for 16-QAM as a range of TBS indices spanning from 14 to 21 for 16-QAM in the Stand-alone or Guard-band deployment; and in a case where the first indication indicates the In-band deployment, interpreting the range of TBS indices for 16-QAM as a range of TBS indices spanning from 11 to 17 for 16-QAM in the In-band deployment.

In an exemplary embodiment, the first indication of said deployment mode is received from the network node in at least one of: system information, or UE specific configuration.

In an exemplary embodiment, the system information includes: MasterInformationBlock-Narrowband (MIB-NB) mapped to Narrowband Physical Broadcast Channel (NPBCH) for anchor carriers, or SystemInformationBlockType22-NB-r14 for non-anchor carriers.

In an exemplary embodiment, the UE specific configuration includes DL-CarrierConfigDedicated-NB for non-anchor carriers.

In an exemplary embodiment, the second indication of the use of 16-QAM and the third indication of the range of TBS indices for 16-QAM are received from the network node in DCI.

In an exemplary embodiment, the use of 16-QAM is indicated in one of reserved states of an MCS field in the DCI, and the range of TBS indices for 16-QAM in said deployment mode is indicated in at least a subset of bits in a repetition field in the DCI.

In an exemplary embodiment, the reserved state of the MCS field in the DCI for indicating the use of 16-QAM is represented by multiple bits in the MCS field in the DCI.

In an exemplary embodiment, in the case where the first indication indicates the In-band deployment, a first range of TBS indices spanning from 11 to 13 for 16-QAM in the In-band deployment is indicated in an MCS field in DCI; and a second range of TBS indices spanning from 14 to 17 for 16-QAM in the In-band deployment is indicated in at least a subset of bits in a repetition field in the DCI.

In an exemplary embodiment, the use of 16-QAM is indicated in a single bit in the DCI.

In an exemplary embodiment, the first indication of said deployment mode, the second indication of the use of 16-QAM, and the third indication of the range of TBS indices for 16-QAM are received from the network node in downlink control information. DCI.

In an exemplary embodiment, the Stand-alone or Guard-band deployment for 16-QAM is indicated in one of reserved states of an MCS field in the DCI, the In-band deployment for 16-QAM is indicated in another of the reserved states of the MCS field in the DCI, and the range of TBS indices for 16-QAM is indicated in at least a subset of bits in a repetition field in the DCI.

In an exemplary embodiment, the reserved state of the MCS field in the DCI for indicating the Stand-alone or Guard-band deployment for 16-QAM, and the reserved state of the MCS field in the DCI for indicating the In-band deployment for 16-QAM are respectively represented by multiple bits in the MCS field in the DCI.

According to a second aspect of the present disclosure, a method at a network node is provided. The method includes: transmitting, to a UE, information including: a first indication of a deployment mode for communication, a second indication of use of 16-QAM, and a third indication of a range of TBS indices for 16-QAM, wherein said deployment mode and the range of TBS indices for 16-QAM are used for indicating the UE to interpret the range of TBS indices for 16-QAM in said deployment mode.

In an exemplary embodiment, the deployment mode includes one of: a Stand-alone deployment, a Guard-band deployment, and an In-band deployment.

In an exemplary embodiment, in a case where the first indication indicates the Stand-alone or Guard-band deployment, the Stand-alone or Guard-band deployment and the range of TBS indices for 16-QAM are used for indicating the UE to interpret a range of TBS indices spanning from 14 to 21 for 16-QAM in the Stand-alone or Guard-band deployment; and in a case where the first indication indicates the In-band deployment, the In-band deployment and the range of TBS indices for 16-QAM are used for indicating the UE to interpret a range of TBS indices spanning from 11 to 17 for 16-QAM in the In-band deployment.

In an exemplary embodiment, the first indication of said deployment mode is transmitted in at least one of: system information, or UE specific configuration.

In an exemplary embodiment, the system information includes: MIB-NB mapped to NPBCH for anchor carriers, or SystemInformationBlockType22-NB-r14 for non-anchor carriers.

In an exemplary embodiment, the UE specific configuration includes DL-CarrierConfigDedicated-NB for non-anchor carriers.

In an exemplary embodiment, the second indication of the use of 16-QAM and the third indication of the range of TBS indices for 16-QAM are transmitted to the UE in DCI.

In an exemplary embodiment, the use of 16-QAM is indicated in one of reserved states of a modulation and coding scheme, MCS, field in the DCI, and the range of TBS indices for 16-QAM in said deployment mode is indicated in at least a subset of bits in a repetition field in the DCI.

In an exemplary embodiment, the reserved state of the MCS field in the DCI for indicating the use of 16-QAM is represented by multiple bits in the MCS field in the DCI.

In an exemplary embodiment, in the case where the first indication indicates the In-band deployment, a first range of TBS indices spanning from 11 to 13 for 16-QAM in the In-band deployment is indicated in a modulation and coding scheme, MCS, field in DCI; and a second range of TBS indices spanning from 14 to 17 for 16-QAM in the In-band deployment is indicated in at least a subset of bits in a repetition field in the DCI.

In an exemplary embodiment, the use of 16-QAM is indicated in a single bit in the DCI.

In an exemplary embodiment, the first indication of said deployment mode, the second indication of the use of 16-QAM, and the third indication of the range of TBS indices for 16-QAM are transmitted to the UE in DCI.

In an exemplary embodiment, the Stand-alone or Guard-band deployment for 16-QAM is indicated in one of reserved states of a modulation and coding scheme, MCS, field in the DCI, the In-band deployment for 16-QAM is indicated in another of the reserved states of the MCS field in the DCI, and the range of TBS indices for 16-QAM is indicated in at least a subset of bits in a repetition field in the DCI.

In an exemplary embodiment, the reserved state of the MCS field in the DCI for indicating the Stand-alone or Guard-band deployment for 16-QAM, and the reserved state of the MCS field in the DCI for indicating the In-band deployment for 16-QAM are respectively represented by multiple bits in the MCS field in the DCI.

According to a third aspect of the present disclosure, a UE is provided. The UE includes: at least one processor, and at least one memory, storing instructions which, when executed on the at least one processor, cause the UE to perform any of the methods according to the first to third aspects of the present disclosure.

According to a fourth aspect of the present disclosure, a network node is provided. The network node includes: at least one processor, and at least one memory, storing instructions which, when executed on the at least one processor, cause the network node to perform any of the methods according to the fourth to sixth aspects of the present disclosure.

According to a fifth aspect of the present disclosure, a computer readable storage medium is provided. The computer readable storage medium has computer program instructions stored thereon, the computer program instructions, when executed by at least one processor, causing the at least one processor to perform the method according to any of the first to sixth aspects of the present disclosure.

According to a sixth aspect of the present disclosure, a communication system is provided. The communication system includes a host computer including: processing circuitry configured to provide user data; and a communication interface configured to forward the user data to a cellular network for transmission to a UE. The cellular network includes a network node, a transmission point, relay node, or an UE having a radio interface and processing circuitry. The network node's processing circuitry is configured to perform the method according to the embodiments the present disclosure.

In an exemplary embodiment, the communication system can further include the network node.

In an exemplary embodiment, the communication system can further include the UE. The UE is configured to communicate with the network node.

In an exemplary embodiment, the processing circuitry of the host computer can be configured to execute a host application, thereby providing the user data. The UE can include processing circuitry configured to execute a client application associated with the host application.

According to a seventh aspect of the present disclosure, a method is provided. The method is implemented in a communication system including a host computer, a network node and a UE. The method includes: at the host computer, providing user data; and at the host computer, initiating a transmission carrying the user data to the UE via a cellular network including the network node. The network node can perform the method according to the embodiments of the present disclosure.

In an exemplary embodiment, the method further can include: at the network node, transmitting the user data.

In an exemplary embodiment, the user data can be provided at the host computer by executing a host application. The method can further include: at the UE, executing a client application associated with the host application.

According to an eighth aspect of the present disclosure, a communication system is provided. The communication system includes a host computer including: processing circuitry configured to provide user data; and a communication interface configured to forward user data to a cellular network for transmission to a UE. The UE includes a radio interface and processing circuitry. The UE's processing circuitry is configured to perform the methods according to the first to third aspects of the present disclosure.

In an exemplary embodiment, the communication system can further include the UE.

In an exemplary embodiment, the cellular network can further include a network node configured to communicate with the UE.

In an exemplary embodiment, the processing circuitry of the host computer can be configured to execute a host application, thereby providing the user data. The UE's processing circuitry can be configured to execute a client application associated with the host application.

According to a ninth aspect of the present disclosure, a method is provided. The method is implemented in a communication system including a host computer, a network node and a UE. The method includes: at the host computer, providing user data; and at the host computer, initiating a transmission carrying the user data to the UE via a cellular network including the network node. The UE can perform the methods according to the first to third aspects of the present disclosure.

In an exemplary embodiment, the method can further include: at the UE, receiving the user data from the network node.

According to a tenth aspect of the present disclosure, a communication system is provided. The communication system includes a host computer including: a communication interface configured to receive user data originating from a transmission from a UE to a network node. The UE includes a radio interface and processing circuitry. The UE's processing circuitry is configured to: perform the methods according to the first to third aspects of the present disclosure.

In an exemplary embodiment, the communication system can further include the UE.

In an exemplary embodiment, the communication system can further include the network node. The network node can include a radio interface configured to communicate with the UE and a communication interface configured to forward to the host computer the user data carried by a transmission from the UE to the network node.

In an exemplary embodiment, the processing circuitry of the host computer can be configured to execute a host application. The UE's processing circuitry can be configured to execute a client application associated with the host application, thereby providing the user data. In an exemplary embodiment, the processing circuitry of the host computer can be configured to execute a host application, thereby providing request data. The UE's processing circuitry can be configured to execute a client application associated with the host application, thereby providing the user data in response to the request data.

According to an eleventh aspect of the present disclosure, a method is provided. The method is implemented in a communication system including a host computer, a network node and a UE. The method includes: at the host computer, receiving user data transmitted to the network node from the UE. The UE can perform the methods according to the first to third aspects of the present disclosure.

In an exemplary embodiment, the method can further include: at the UE, providing the user data to the network node.

In an exemplary embodiment, the method can further include: at the UE, executing a client application, thereby providing the user data to be transmitted; and at the host computer, executing a host application associated with the client application.

In an exemplary embodiment, the method can further include: at the UE, executing a client application; and at the UE, receiving input data to the client application, the input data being provided at the host computer by executing a host application associated with the client application. The user data to be transmitted is provided by the client application in response to the input data.

According to a twelfth aspect of the present disclosure, a communication system is provided. The communication system includes a host computer including a communication interface configured to receive user data originating from a transmission from a UE to a network node. The network node includes a radio interface and processing circuitry. The network node's processing circuitry is configured to perform the method according to the fourth to sixth aspects of the present disclosure.

In an exemplary embodiment, the communication system can further include the network node. In an exemplary embodiment, the communication system can further include the UE. The UE can be configured to communicate with the network node.

In an exemplary embodiment, the processing circuitry of the host computer can be configured to execute a host application; the UE can be configured to execute a client application associated with the host application, thereby providing the user data to be received by the host computer.

According to a thirteenth aspect of the present disclosure, a method is provided. The method is implemented in a communication system including a host computer, a network node and a UE. The method includes: at the host computer, receiving, from the network node, user data originating from a transmission which the network node has received from the UE. The network node can perform the method according to the fourth to sixth aspects of the present disclosure.

In an exemplary embodiment, the method can further include: at the network node, receiving the user data from the UE.

In an exemplary embodiment, the method can further include: at the network node, initiating a transmission of the received user data to the host computer.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 schematically shows a method at a UE for TBS index range interpretation for 16-QAM in different deployment modes according to an exemplary embodiment of the present disclosure;

FIG. 2 schematically shows a method at a UE for TBS index range interpretation for 16-QAM in In-band deployment according to an exemplary embodiment of the present disclosure;

FIG. 3 schematically shows a method at a network node for TBS index range interpretation for 16-QAM in different deployment modes according to an exemplary embodiment of the present disclosure;

FIG. 4 schematically shows a method at a network node for TBS index range interpretation for 16-QAM in In-band deployment according to an exemplary embodiment of the present disclosure;

FIG. 5 schematically shows a structural block diagram of a UE according to an exemplary embodiment of the present disclosure;

FIG. 6 schematically shows a structural block diagram of a UE according to another exemplary embodiment of the present disclosure;

FIG. 7 schematically shows a structural block diagram of a network node according to an exemplary embodiment of the present disclosure;

FIG. 8 schematically shows a structural block diagram of a network node according to another exemplary embodiment of the present disclosure;

FIG. 9 schematically illustrates a schematic diagram of an exemplary network architecture illustrating a communication system connected via an intermediate network to a host computer according to the principles in the present disclosure;

FIG. 10 schematically illustrates a generalized block diagram of a host computer communicating via a network node with a UE over an at least partially wireless connection according to some embodiments of the present disclosure;

FIG. 11 schematically illustrates a flowchart illustrating exemplary methods implemented in a communication system including a host computer, a network node and a UE for executing a client application at a UE according to some embodiments of the present disclosure;

FIG. 12 schematically illustrates a flowchart illustrating exemplary methods implemented in a communication system including a host computer, a network node and a UE for receiving user data at a UE according to some embodiments of the present disclosure;

FIG. 13 schematically illustrates a flowchart illustrating exemplary methods implemented in a communication system including a host computer, a network node and a UE for receiving user data from the UE at a host computer according to some embodiments of the present disclosure; and

FIG. 14 schematically illustrates a flowchart illustrating exemplary methods implemented in a communication system including a host computer, a network node and a UE for receiving user data at a host computer according to some embodiments of the present disclosure.

### DETAILED DESCRIPTION

In 3GPP, there have been initial discussions on possible DCI designs to support 16-QAM in DL. The candidate designs describe ways in which one or more DCI fields can be re-used to indicate the use of 16-QAM in DL and the range of the so called “I_TBS indices used for 16-QAM”.

For example, there may be several options for DCI design on the indication of DL 16-QAM:
Option 1: MCS field is increased to 5 bits to indicate modulation and TBS, and repetition field is reduced to 3 bits to indicate the repetition number;
Option 2: MCS field is 4 bits to indicate TBS, and repetition field is reduced to 3 bits to indicate the repetition number;
   1 bit is used to indicate legacy QPSK or 16-QAM
Option 3: MCS field is 4 bits to indicate modulation and TBS
   A reserved state of MCS field indicates use of 16-QAM,
   Repetition field indicates 16-QAM MCS if 16-QAM is indicated to be used.
Option 4: MCS field is 4 bits,
   If repetition is indicated as one, 16-QAM and QPSK can be indicated by MCS field;
   If repetition is indicated larger than one, the legacy QPSK MCS can be indicated by MCS field.
Option 5: {repetition, MCS} are indicated by 8 bits (a combination of the MCS field and repetition field)
Note: other options are not precluded.

However, it has been left completely open or unaddressed what is going to be the methods to distinguish between different deployment modes (i.e., Stand-alone, Guard-band, and In-band deployments).

Some exemplary embodiments of the present disclosure advantageously provide methods, apparatuses, and media for TBS index range interpretation for 16-QAM in different deployment modes, which incorporate additional aspects that have not been incorporated yet into the options listed towards preparing the DCI design for 16-QAM in DL.

Before describing in detail exemplary embodiments, it is noted that the embodiments reside primarily in combinations of apparatus components and processing steps related to supporting/implementing 16-quadrature amplitude modulation (16-QAM) based communication based on at least one of: time-domain resource assignment rearrangement, and transport block redistribution.

Accordingly, components have been represented where appropriate by conventional symbols in the drawings, showing only those specific details that are pertinent to understanding the embodiments so as not to obscure the present disclosure with details that will be readily apparent to those of ordinary skill in the art having the benefit of the description herein. Like numbers refer to like elements throughout the description.

As used herein, relational terms, such as “first” and “second.” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term. “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled.” “connected.” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes. Remote Radio Unit (RRU) Remote Radio Head (RRH), a core network node (e.g., mobile management entity (MME), self-organizing network (SON) node, a coordinating node, positioning node. MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device such as a wireless device or a radio network node.

In some embodiments, the non-limiting terms wireless device or a user equipment (UE) are used interchangeably. The UE herein can be any type of wireless device capable of communicating with a network node or another wireless device over radio signals, such as wireless device. The UE may also be a radio communication device, target device, device to device (D2D) wireless device, machine type wireless device or wireless device capable of machine to machine communication (M2M), low-cost and/or low-complexity wireless device, a sensor equipped with wireless device. Tablet, mobile terminals, smart phone, laptop embedded equipped (LEE), laptop mounted equipment (LME). USB dongles. Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB). Node B, gNB. Multi-cell/multicast Coordination Entity (MCE). IAB node, relay node, access point, radio access point. Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the present disclosure to only the aforementioned system. Other wireless systems, including without limitation Wide Band Code Division Multiple Access (WCDMA). Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

One or more embodiments of the present disclosure mainly focus on:
I_TBS index range interpretation for “Stand-alone or Guard-band or In-band deployment” from information about the corresponding deployment mode that can be obtained from system information (such as MIB-NB for anchor carriers, SystemInformationBlockType22-NB-r14 for non-anchor carriers) and/or UE specific configuration (such as DL-CarrierConfigDedicated-NB for non-anchor carriers)
I_TBS index range interpretation for “Stand-alone or Guard-band or In-band deployment” from DCI, such as two of reserved states in the MCS field in DCI.

There may be one or more advantages related to one or more embodiments described herein. For example,

For the embodiments of I_TBS index range interpretation for “Stand-alone or Guard-band or In-band deployment” from information about the corresponding deployment mode that can be obtained from the system information and/or the UE specific configuration,
one reserved state in DCI that otherwise will be needed to distinguish between “Stand-alone/Guard-band” and “In-band” deployments may be saved;
the distinction between different I_TBS index ranges used by different deployment modes may be performed with the L1-signaling kept un-impacted; and
the information about the deployment mode available in system information and/or UE specific configuration may be reused.

For the embodiments of I_TBS index range interpretation for “Stand-alone or Guard-band or In-band deployment” from DCI (such as two reserved states in the MCS field in DCI),
explicit L1-signaling distinguishing between different I_TBS index ranges used by different deployment modes may be provided; and
the L1-signaling distinction does not need to further distinguish between anchor and non-anchor carriers.

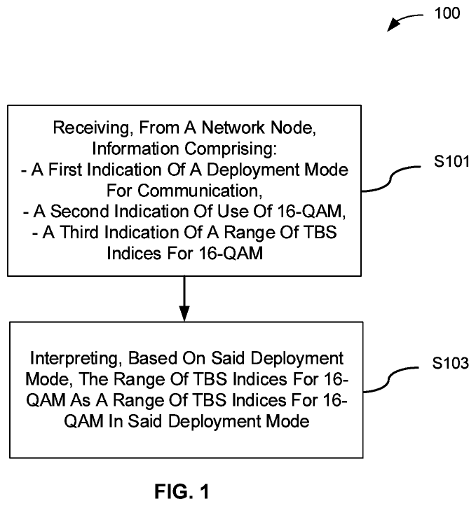

Hereinafter, a method 100 at a UE for TBS index range interpretation for 16-QAM in different deployment modes according to an exemplary embodiment of the present disclosure will be described with reference to FIG. 1.

As shown in FIG. 1, the method 100 may include at least steps S101 and S103.

In step S101, the UE may receive, from a network node, information including the following indications:
a first indication of a deployment mode for communication,
a second indication of use of 16-QAM, and
a third indication of a range of TBS indices for 16-QAM.

As previously described, the deployment mode may include: a Stand-alone deployment, a Guard-band deployment, and an In-band deployment.

Then in step S103, the UE may interpret, based on the deployment mode indicated in the received information, the range of TBS indices for 16-QAM as a range of TBS indices for 16-QAM in the deployment mode.

Alternatively or additionally, in a case where the first indication indicates the Stand-alone or Guard-band deployment, the UE may interpret, in step S103, the range of TBS indices for 16-QAM as a range of TBS indices spanning from 14 to 21 for 16-QAM in the Stand-alone or

Guard-band deployment; and in a case where the first indication indicates the In-band deployment, the UE may interpret, in step S103, the range of TBS indices for 16-QAM as a range of TBS indices spanning from 11 to 17 for 16-QAM in the In-band deployment.

The above technical solution of the present disclosure will be described in several exemplary embodiments as follows.

### First Exemplary Embodiment

In the first exemplary embodiment, different ranges of TBS indices used by different deployment modes are distinguished using information about the corresponding deployment mode that can be obtained from system information (such as MIB-NB for anchor carriers, SystemInformationBlockType22-NB-r14 for non-anchor carriers) and/or UE specific configuration (such as DL-CarrierConfigDedicated-NB for non-anchor carriers).

The first indication of the deployment mode may be received from the network node in at least one of:
system information, or
UE specific configuration.

The system information may include e.g.:
MasterInformationBlock-Narrowband (MIB-NB) (c.f. Clause 6.7.2 of 3GPP TS 36.331 V16.4.0, which is incorporated herein in its entirety by reference), mapped to e.g. Narrowband Physical Broadcast Channel (NPBCH) for anchor carriers, or
SystemInformationBlockType22-NB-r14 (c.f. Clause 6.7.2 of 3GPP TS 36.331 V16.4.0) for non-anchor carriers.

The UE specific configuration may include e.g., DL-CarrierConfigDedicated-NB for non-anchor carriers (c.f. Clause 6.7.3 of 3GPP TS 36.331 V16.4.0, which is incorporated herein in its entirety by reference).

The second indication of the use of 16-QAM and the third indication of the range of TBS indices for 16-QAM may be received from the network node in DCI.

As previously described, one or more DCI fields can be re-used to indicate the use of 16-QAM and the range of TBS indices for 16-QAM.

In one implementation, the use of 16-QAM may be indicated in one of reserved states of a MCS field in the DCI. The reserved state of the MCS field in the DCI for indicating the use of 16-QAM may be represented by multiple bits in the MCS field in the DCI. And the range of TBS indices for 16-QAM in the deployment mode may be indicated in at least a subset of bits in a repetition field in the DCI. This implementation will be exemplarily described in detail in conjunction with e.g. Option 3 for DCI design.

For illustration purposes without any limitation, Option 3 as described previously is taken as an example of DCI design. However, it should be understood that the first exemplary embodiment may be applied to any of Options 1˜5 or other possible Options for DCI design that are not listed here.

As per the agreements reached in 3GPP “Stand-alone and Guard-band deployments”, they both use the same range of TBS indices, whereas the “In-band deployment” uses a different range of TBS indices.

In DL, Option 3 aims at utilizing the following two fields (the MCS field represented by “Modulation and coding scheme” and the repetition field represented by “Repetition number”) in e.g., DCI Format N1 (c.f. Clause 6.4.3.2 of 3GPP TS 36.212 V16.5.0, which is incorporated herein in its entirety by reference):
Modulation and coding scheme—4 bits as defined in Clause 16.4.1.5 of 3GPP TS 36.213 V16.5.0, which is incorporated herein in its entirety by reference. Since the states “1110” and “1111” are reserved (not used), any of those reserved states can be used to indicate the use of 16-QAM;
Repetition number—4 bits as defined in Clause 16.4.1.3 of 3GPP TS 36.213 V16.5.0, which is incorporated herein in its entirety by reference. If “Modulation and coding scheme” indicates the use of 16-QAM by e.g. “1110”, since repetitions are not used for 16-QAM, 3-bits of this repetition field (i.e., a subset of the bits in the repetition field) can be used to indicate the range of TBS indices for 16-QAM in DL as follows:
If the information about the deployment mode that can be obtained from system information (such as MIB-NB for anchor carriers, SystemInformationBlockType22-NB-r14 for non-anchor carriers) and/or UE specific configuration (such as DL-CarrierConfigDedicated-NB for non-anchor carriers) indicates “Stand-alone or Guard-band deployment”, the 3-bits of this repetition field is interpreted by the UE as the range of TBS indices spanning from index 14 to 21.
If this information about the deployment mode indicates “In-band deployment”, the 3-bits of this repetition field is interpreted by the UE as the range of TBS indices spanning from index 11 to 17.

Alternatively or additionally, in the case where the first indication indicates the In-band deployment,
a first range of TBS indices spanning from 11 to 13 for 16-QAM in the In-band deployment is indicated in a modulation and coding scheme, MCS, field in DCI; and
a second range of TBS indices spanning from 14 to 17 for 16-QAM in the In-band deployment is indicated in at least a subset of bits in a repetition field in the DCI.

As previously described, the first exemplary embodiment of the present disclosure may be applied to any other options for DCI design to support 16-QAM in DL.

By taking Option 2 as another example, in which the MCS field is 4 bits to indicate TBS, 1 bit in the repetition field is “lent” to indicate legacy QPSK or 16QAM, and the repetition field is reduced to 3 bits to indicate the repetition number.

Therefore, the use of 16-QAM may be indicated in a single bit in the DCI, and the interpretation of the range of TBS indices for 16-QAM in DL for different deployment modes is as follows:
If the information about the deployment mode indicates “Stand-alone or Guard-band deployment”, the 4-bits in the MCS field is interpreted by the UE as the range of TBS indices spanning from index 14 to 21.
If this information about the deployment mode indicates “In-band deployment”, the 4-bits in the MCS field is interpreted by the UE as the range of TBS indices spanning from index 11 to 17.

### Second Exemplary Embodiment

In the second exemplary embodiment, different ranges of TBS indices used by different deployment modes are distinguished using DCI, such as two of reserved states in the MCS field in DCI.

In particular, the first indication of the deployment mode, the second indication of the use of 16-QAM, and the third indication of the range of TBS indices for 16-QAM may be received from the network node in DCI.

Preferably, the first indication of said deployment mode may be indicated in one of reserved states of the MCS field in the DCI.

In particular, the Stand-alone or Guard-band deployment for 16-QAM may be indicated in one of reserved states of the MCS field in the DCI, and the In-band deployment for 16-QAM may be indicated in another of the reserved states of the MCS field in the DCI. And the range of TBS indices for 16-QAM may be indicated in at least a subset of bits in a repetition field in the DCI.

The reserved state of the MCS field in the DCI for indicating the Stand-alone or Guard-band deployment for 16-QAM, and the reserved state of the MCS field in the DCI for indicating the In-band deployment for 16-QAM may be respectively represented by multiple bits in the MCS field in the DCI.

This implementation will be exemplarily described in detail in conjunction with e.g. Option 3 for DCI design.

Again, for illustration purposes without any limitation, Option 3 as described previously is taken as an example of DCI design. However, it should be understood that the second exemplary embodiment may be applied to other possible Options for DCI design that make use of such DCI fields.

As per the agreements reached in 3GPP “Stand-alone and Guard-band deployments”, they both use the same range of TBS indices, whereas the “In-band deployment” uses a different range of TBS indices.

In DL, Option 3 aims at utilizing the following two fields (the MCS field represented by “Modulation and coding scheme” and the repetition field represented by “Repetition number”) in e.g., DCI Format N1:
Modulation and coding scheme—4 bits as defined in Clause 16.4.1.5 of 3GPP TS 36.213 V16.5.0. Since the states “1110” and “1111” are reserved (not used), they may be used to indicate the use of 16-QAM. Also, the states “1110” and “1111” may be used to indicate “Stand-alone/Guard-band deployment” and “In-band deployment” respectively. That is, the states “1110” and “1111” may be used to indicate “Stand-alone/Guard-band deployment” and “In-band deployment” for 16-QAM, respectively. For example, state 1110 indicates “Stand-alone/Guard-band deployment” for 16-QAM, and state 1111 indicates “In-band deployment” for 16-QAM, or vice versa.
Repetition number—4 bits as defined in Clause 16.4.1.3 of 3GPP TS 36.213 V16.5.0. If “Modulation and coding scheme” indicates either state “1110” or “1111”, since repetitions are not used for 16-QAM, 3 bits of this repetition field (i.e., a subset of the bits in the repetition field) can be used to indicate the range of TBS indices for 16-QAM in DL as follows:
If “Modulation and coding scheme” indicates state “1110”, the “Repetition number” using 3-bits indicates TBS indices for “Stand-alone/Guard-band deployments” spanning from index 14 to 21. Thus, the 3-bits of this repetition field is interpreted by the UE as the range of TBS indices spanning from index 14 to 21.
If “Modulation and coding scheme” indicates state “1111”, the “Repetition number” using 3-bits indicates TBS indices for “in-band deployments” spanning from index 11 to 17. Thus, the 3-bits of this repetition field is interpreted by the UE as the range of TBS indices spanning from index 11 to 17.

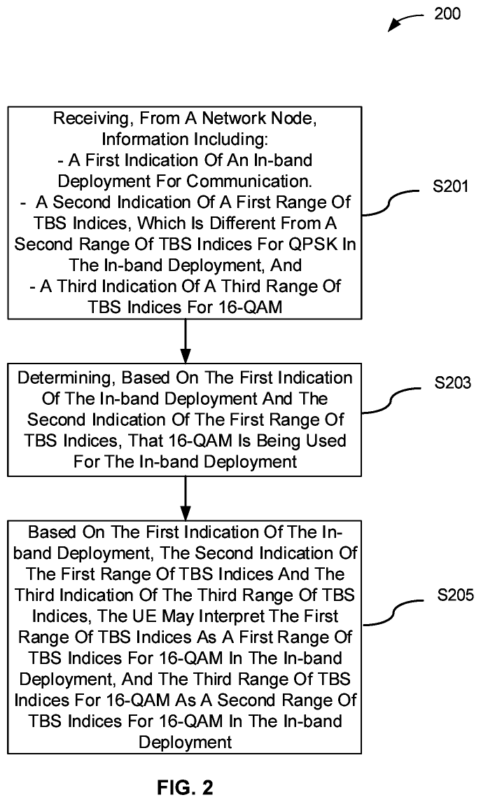

Hereinafter, a method 200 at a UE for TBS index range interpretation for 16-QAM in In-band deployment according to an exemplary embodiment of the present disclosure will be described with reference to FIG. 2.

As shown in FIG. 2, the method 200 may include at least steps S201˜S207.

In step S201, the UE may receive, from a network node, information including the following indications:
a first indication of an In-band deployment for communication,
a second indication of a first range of TBS indices, which is different from a second range of TBS indices for QPSK in the In-band deployment, and
a third indication of a third range of TBS indices for 16-QAM.

In step S203, the UE may determine, based on the first indication of the In-band deployment and the second indication of the first range of TBS indices, that 16-QAM is being used for the In-band deployment.

Then in step S205, based on the first indication of the In-band deployment, the second indication of the first range of TBS indices and the third indication of the third range of TBS indices for 16-QAM, the UE may interpret the first range of TBS indices as a first range of TBS indices for 16-QAM in the In-band deployment, and the third range of TBS indices for 16-QAM as a second range of TBS indices for 16-QAM in the In-band deployment.

Alternatively or additionally, in step S205, the UE may interpret the first range of TBS indices indicated in the received second information as a first range of TBS indices spanning from 11 to 13 for 16-QAM in the In-band deployment, and interpret the third range of TBS indices for 16-QAM indicated in the received second information as a second range of TBS indices spanning from 14 to 17 for 16-QAM in the In-band deployment.

Similar with the first exemplary embodiment, in this exemplary embodiment, the information about the In-band deployment may be obtained from system information (such as MIB-NB for anchor carriers, SystemInformationBlockType22-NB-r14 for non-anchor carriers) and/or UE specific configuration (such as DL-CarrierConfigDedicated-NB for non-anchor carriers).

The second indication of the first range of TBS indices and the third indication of the third range of TBS indices for 16-QAM may be received from the network node in DCI.

Preferably, the first range of TBS indices may be indicated in an MCS field in the DCI, and the third range of TBS indices for 16-QAM in In-band deployment may be indicated in at least a subset of bits in a repetition field in the DCI.

This implementation will be exemplarily described in detail in conjunction with e.g. Option 3 for DCI design.

Again, for illustration purposes without any limitation, Option 3 as described previously is taken as an example of DCI design. However, it should be understood that this exemplary embodiment may be applied to other possible Options for DCI design that make use of such DCI fields.

In legacy, the range of TBS indices for QPSK in the In-band deployment spans from 0 to 10 as shown in Table 2. Under this assumption, if the first indication indicates an In-band deployment and if I_TBS indices 11 to 13 were indicated in the 4 bits from “Modulation and coding scheme”, the UE can determine that 16-QAM is being used (recall that those I_TBS indices are not used in In-band deployment for QPSK).

Based on this, the UE may interpret the I_TBS indices 11 to 13 indicated in the 4 bits from “Modulation and coding scheme” as the first range of TBS indices spanning from 11 to 13 for 16-QAM in the In-band deployment, and interpret the 3-bits from “Repetition number” as the range of TBS indices spanning from 14 to 17 for 16-QAM in the In-band deployment.

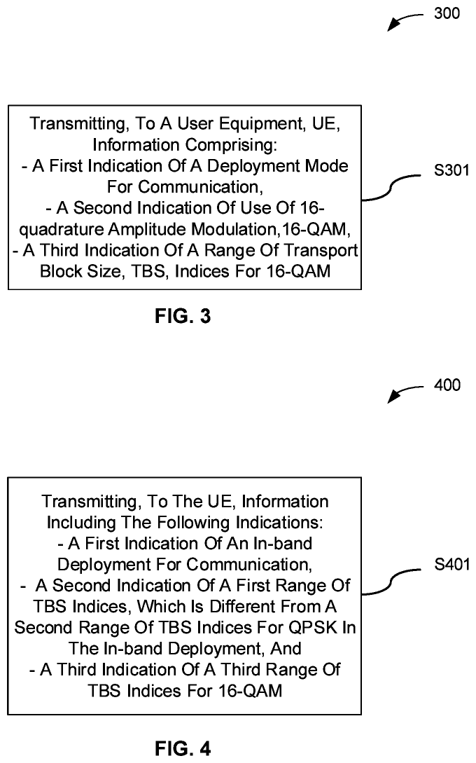

Hereinafter, a method 300 at a network node for TBS index range interpretation for 16-QAM in different deployment modes according to an exemplary embodiment of the present disclosure will be described with reference to FIG. 3. It should be understood that the method 300 at the network node corresponds to the method 100 at the UE as previously described. Thus, some description of the method 300 may refer to that of method 100, and thus will be omitted for simplicity.

As shown in FIG. 3, the method 300 may include at least step S301, in which the network node may transmit, to a UE, information including the following indications:
a first indication of a deployment mode for communication,
a second indication of use of 16-QAM.
a third indication of a range of TBS indices for 16-QAM.

As previously described, the deployment mode may include: a Stand-alone deployment, a Guard-band deployment, and an In-band deployment.

The deployment mode and the range of TBS indices for 16-QAM may be used for indicating the UE to interpret the range of TBS indices for 16-QAM in the deployment mode. That is, when the UE receives the information including the above indications, the UE may interpret, based on the deployment mode indicated in the received information, the range of TBS indices for 16-QAM as a range of TBS indices for 16-QAM in the deployment mode.

Alternatively or additionally, in a case where the first indication indicates the Stand-alone or Guard-band deployment, the Stand-alone or Guard-band deployment and the range of TBS indices for 16-QAM are used for indicating the UE to interpret a range of TBS indices spanning from 14 to 21 for 16-QAM in the Stand-alone or Guard-band deployment; and in a case where the first indication indicates the In-band deployment, the In-band deployment and the range of TBS indices for 16-QAM are used for indicating the UE to interpret a range of TBS indices spanning from 11 to 17 for 16-QAM in the In-band deployment.

In the first exemplary embodiment which has been described previously for the UE, different ranges of TBS indices used by different deployment modes are distinguished using information about the corresponding deployment mode that can be obtained from system information (such as MIB-NB for anchor carriers, SystemInformationBlockType22-NB-r14 for non-anchor carriers) and/or UE specific configuration (such as DL-CarrierConfigDedicated-NB for non-anchor carriers).

The first indication of the deployment mode may be transmitted in at least one of:
system information, or
UE specific configuration.

The system information may include e.g.:
MIB-NB (c.f. Clause 6.7.2 of 3GPP TS 36.331 V16.4.0) mapped to e.g. NPBCH for anchor carriers, or
SystemInformationBlockType22-NB-r14 (c.f. Clause 6.7.2 of 3GPP TS 36.331 V16.4.0) for non-anchor carriers.

The UE specific configuration may include e.g., DL-CarrierConfigDedicated-NB for non-anchor carriers (c.f. Clause 6.7.3 of 3GPP TS 36.331 V16.4.0, which is incorporated herein in its entirety by reference).

The second indication of the use of 16-QAM and the third indication of the range of TBS indices for 16-QAM may be received from the network node in DCI.

As previously described, one or more DCI fields can be re-used to indicate the use of 16-QAM and the range of TBS indices for 16-QAM.

In one implementation, the use of 16-QAM may be indicated in one of reserved states of a MCS field in the DCI. The reserved state of the MCS field in the DCI for indicating the use of 16-QAM may be represented by multiple bits in the MCS field in the DCI. And the range of TBS indices for 16-QAM in the deployment mode may be indicated in at least a subset of bits in a repetition field in the DCI.

The implementation exemplarily described in detail in conjunction with e.g. Option 3 for DCI design may refer to that at the UE as previously described, which will be omitted here for simplicity.

Alternatively or additionally, in the case where the first indication indicates the In-band deployment,
a first range of TBS indices spanning from 11 to 13 for 16-QAM in the In-band deployment is indicated in a modulation and coding scheme, MCS, field in DCI; and
a second range of TBS indices spanning from 14 to 17 for 16-QAM in the In-band deployment is indicated in at least a subset of bits in a repetition field in the DCI.

As previously described, the first exemplary embodiment of the present disclosure may be applied to any other options for DCI design to support 16-QAM in DL.

For example, with e.g., Option 2 for DCI design, the use of 16-QAM may be indicated in a single bit in the DCI. The implementation exemplarily described in detail in conjunction with e.g. Option 2 for DCI design may refer to that at the UE, which will be omitted here for simplicity.

In the second exemplary embodiment which has been described previously for the UE, different ranges of TBS indices used by different deployment modes are distinguished using DCI, such as two of reserved states in the MCS field in DCI.

In particular, the first indication of the deployment mode, the second indication of the use of 16-QAM, and the third indication of the range of TBS indices for 16-QAM may be transmitted to the UE in DCI.

Preferably, the first indication of said deployment mode may be indicated in one of reserved states of the MCS field in the DCI.

In particular, the Stand-alone or Guard-band deployment for 16-QAM may be indicated in one of reserved states of the MCS field in the DCI, and the In-band deployment for 16-QAM may be indicated in another of the reserved states of the MCS field in the DCI. And the range of TBS indices for 16-QAM may be indicated in at least a subset of bits in a repetition field in the DCI.

The reserved state of the MCS field in the DCI for indicating the Stand-alone or Guard-band deployment for 16-QAM, and the reserved state of the MCS field in the DCI for indicating the In-band deployment for 16-QAM may be respectively represented by multiple bits in the MCS field in the DCI.

The implementation exemplarily described in conjunction with e.g. Option 3 for DCI design may refer to that at the UE as previously described, which will be omitted here for simplicity.

Hereinafter, a method 400 at a network node for TBS index range interpretation for 16-QAM in In-band deployment according to an exemplary embodiment of the present disclosure will be described with reference to FIG. 4.

As shown in FIG. 4, the method 400 may include at least step S401, in which the network node may transmit, to the UE, information including the following indications:
a first indication of an In-band deployment for communication,
a second indication of a first range of TBS indices, which is different from a second range of TBS indices for QPSK in the In-band deployment, and
a third indication of a third range of TBS indices for 16-QAM.

The information including the above indications may be used for indicating the UE to interpret the range of TBS indices for 16-QAM in the deployment mode. That is, when the UE receives the information including the above indications, the UE may determine, based on the first indication of the In-band deployment and the second indication of the first range of TBS indices, that 16-QAM is being used for the In-band deployment; and may interpret, based on the first indication of the In-band deployment, the second indication of the first range of TBS indices and the third indication of the third range of TBS indices for 16-QAM, the first range of TBS indices as a first range of TBS indices for 16-QAM in the In-band deployment, and the third range of TBS indices for 16-QAM as a second range of TBS indices for 16-QAM in the In-band deployment.

Alternatively or additionally, the first range of TBS indices indicated in the received second information may be used for the UE to interpret as the first range of TBS indices spanning from 11 to 13 for 16-QAM in the In-band deployment, and the third range of TBS indices for 16-QAM indicated in the received second information may be used for the UE to interpret as the second range of TBS indices spanning from 14 to 17 for 16-QAM in the In-band deployment.

Similar with the first exemplary embodiment, in this exemplary embodiment, the information about the In-band deployment may be obtained from system information (such as MIB-NB for anchor carriers, SystemInformationBlockType22-NB-r14 for non-anchor carriers) and/or UE specific configuration (such as DL-CarrierConfigDedicated-NB for non-anchor carriers).

The second indication of the first range of TBS indices and the third indication of the third range of TBS indices may be transmitted to the UE in DCI.

Preferably, the first range of TBS indices may be indicated in an MCS field in the DCI, and the third range of TBS indices for 16-QAM in In-band deployment may be indicated in at least a subset of bits in a repetition field in the DCI.

The implementation exemplarily described in conjunction with e.g. Option 3 for DCI design may refer to that at the UE as previously described, which will be omitted here for simplicity.

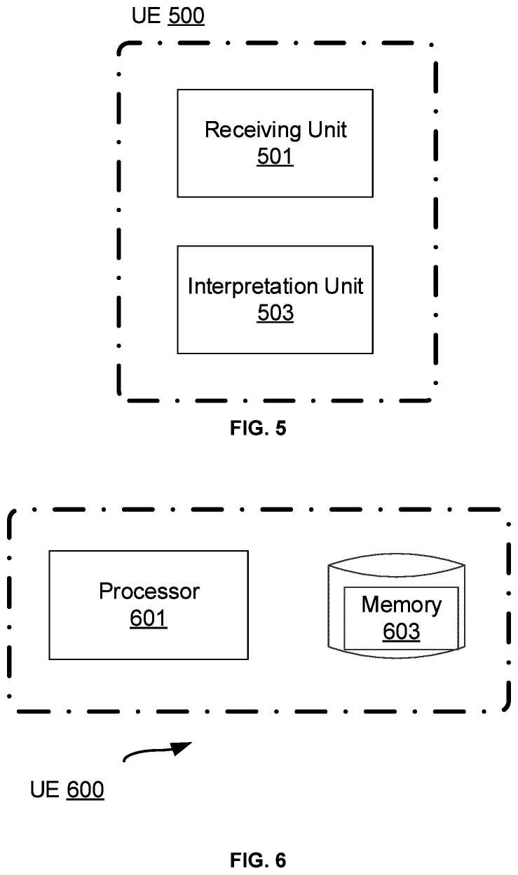

Hereinafter, a structure of a UE according to an exemplary embodiment of the present disclosure will be described with reference to FIG. 5. FIG. 5 schematically shows a block diagram of the UE 500 according to an exemplary embodiment of the present disclosure. The UE 500 in FIG. 5 may perform the methods 100 and 200 as described previously with reference to FIGS. 1 and 2, respectively. Accordingly, some detailed description on the UE 500 may refer to the corresponding description of the method 100 in FIG. 1 and the method 200 in FIG. 2, and thus will be omitted here for simplicity.

As shown in FIG. 5, the UE 500 may include at least a receiving unit 501 and an interpretation unit 503.

The receiving unit 501 may be configured to receive, from a network node, information including: a first indication of a deployment mode for communication, a second indication of use of 16-QAM, and a third indication of a range of TBS indices for 16-QAM.

The interpretation unit 503 may be configured to interpret, based on said deployment mode, the range of TBS indices for 16-QAM as a range of TBS indices for 16-QAM in said deployment mode.

In an exemplary embodiment, the deployment mode includes one of: a Stand-alone deployment, a Guard-band deployment, and an In-band deployment.

In an exemplary embodiment, the interpretation unit 503 may be configured to: in a case where the first indication indicates the Stand-alone or Guard-band deployment, interpret the range of TBS indices for 16-QAM as a range of TBS indices spanning from 14 to 21 for 16-QAM in the Stand-alone or Guard-band deployment; and in a case where the first indication indicates the In-band deployment, interpret the range of TBS indices for 16-QAM as a range of TBS indices spanning from 11 to 17 for 16-QAM in the In-band deployment.

In an exemplary embodiment, the first indication of said deployment mode is received from the network node in at least one of: system information, or UE specific configuration.

In an exemplary embodiment, the system information includes: MIB-NB mapped to NPBCH for anchor carriers, or SystemInformationBlockType22-NB-r14 for non-anchor carriers.

In an exemplary embodiment, the UE specific configuration includes DL-CarrierConfigDedicated-NB for non-anchor carriers.

In an exemplary embodiment, the second indication of the use of 16-QAM and the third indication of the range of TBS indices for 16-QAM are received from the network node in DCI.

In an exemplary embodiment, the use of 16-QAM is indicated in one of reserved states of an MCS field in the DCI, and the range of TBS indices for 16-QAM in said deployment mode is indicated in at least a subset of bits in a repetition field in the DCI.

In an exemplary embodiment, the reserved state of the MCS field in the DCI for indicating the use of 16-QAM is represented by multiple bits in the MCS field in the DCI.

In an exemplary embodiment, in the case where the first indication indicates the In-band deployment, a first range of TBS indices spanning from 11 to 13 for 16-QAM in the In-band deployment is indicated in an MCS field in DCI; and a second range of TBS indices spanning from 14 to 17 for 16-QAM in the In-band deployment is indicated in at least a subset of bits in a repetition field in the DCI.

In an exemplary embodiment, the use of 16-QAM is indicated in a single bit in the DCI.

In an exemplary embodiment, the first indication of said deployment mode, the second indication of the use of 16-QAM, and the third indication of the range of TBS indices for 16-QAM are received from the network node in downlink control information. DCI.

In an exemplary embodiment, the Stand-alone or Guard-band deployment for 16-QAM is indicated in one of reserved states of an MCS field in the DCI, the In-band deployment for 16-QAM is indicated in another of the reserved states of the MCS field in the DCI, and the range of TBS indices for 16-QAM is indicated in at least a subset of bits in a repetition field in the DCI.

In an exemplary embodiment, the reserved state of the MCS field in the DCI for indicating the Stand-alone or Guard-band deployment for 16-QAM, and the reserved state of the MCS field in the DCI for indicating the In-band deployment for 16-QAM are respectively represented by multiple bits in the MCS field in the DCI.

Hereinafter, a structure of a UE according to another exemplary embodiment of the present disclosure will be described with reference to FIG. 6. FIG. 6 schematically shows a block diagram of a UE 600 according to an exemplary embodiment of the present disclosure. The UE 600 in FIG. 6 may perform the methods 100 and 200 as described previously with reference to FIGS. 1 and 2, respectively. Accordingly, some detailed description on the UE 600 may refer to the corresponding description of the method 100 in FIG. 1 and the method 200 in FIG. 2, and thus will be omitted here for simplicity.

As shown in FIG. 6, the UE 600 includes at least one processor 601 and at least one memory 603. The at least one processor 601 includes e.g., any suitable CPU (Central Processing Unit), microcontroller. DSP (Digital Signal Processor), etc., capable of executing computer program instructions. The at least one memory 603 may be any combination of a RAM (Random Access Memory) and a ROM (Read Only Memory). The at least one memory 603 may also include persistent storage, which, for example, can be any single one or combination of magnetic memory, optical memory, or solid state memory or even remotely mounted memory.

The at least one memory 603 stores instructions executable by the at least one processor 601. The instructions, when loaded from the at least one memory 603 and executed on the at least one processor 601, may cause the node 600 to perform the actions, e.g., of the procedures as described earlier respectively in conjunction with FIGS. 1 and 2, and thus will be omitted here for simplicity.

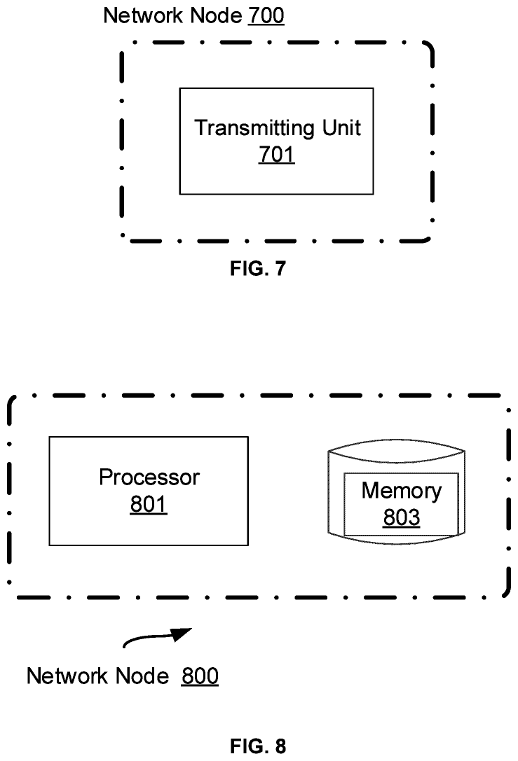

Hereinafter, a structure of a network node according to an exemplary embodiment of the present disclosure will be described with reference to FIG. 7. FIG. 7 schematically shows a block diagram of the network node 700 according to an exemplary embodiment of the present disclosure. The network node 700 in FIG. 7 may perform the methods 300 and 400 as described previously with reference to FIGS. 3 and 4, respectively. Accordingly, some detailed description on the network node 700 may refer to the corresponding description of the method 300 in FIG. 3 and the method 400 in FIG. 4, and thus will be omitted here for simplicity.

As shown in FIG. 7, the network node 700 may include at least a transmitting unit 701, which may be configured to transmit, to a UE, information including: a first indication of a deployment mode for communication, a second indication of use of 16-QAM, and a third indication of a range of TBS indices for 16-QAM, wherein said deployment mode and the range of TBS indices for 16-QAM are used for indicating the UE to interpret the range of TBS indices for 16-QAM in said deployment mode.

In an exemplary embodiment, the deployment mode includes one of: a Stand-alone deployment, a Guard-band deployment, and an In-band deployment.

In an exemplary embodiment, in a case where the first indication indicates the Stand-alone or Guard-band deployment, the Stand-alone or Guard-band deployment and the range of TBS indices for 16-QAM are used for indicating the UE to interpret a range of TBS indices spanning from 14 to 21 for 16-QAM in the Stand-alone or Guard-band deployment; and in a case where the first indication indicates the In-band deployment, the In-band deployment and the range of TBS indices for 16-QAM are used for indicating the UE to interpret a range of TBS indices spanning from 11 to 17 for 16-QAM in the In-band deployment.

In an exemplary embodiment, the first indication of said deployment mode is transmitted in at least one of: system information, or UE specific configuration.

In an exemplary embodiment, the system information includes: MIB-NB mapped to NPBCH for anchor carriers, or SystemInformationBlockType22-NB-r14 for non-anchor carriers.

In an exemplary embodiment, the UE specific configuration includes DL-CarrierConfigDedicated-NB for non-anchor carriers.

In an exemplary embodiment, the second indication of the use of 16-QAM and the third indication of the range of TBS indices for 16-QAM are transmitted to the UE in DCI.

In an exemplary embodiment, the use of 16-QAM is indicated in one of reserved states of a modulation and coding scheme. MCS, field in the DCI, and the range of TBS indices for 16-QAM in said deployment mode is indicated in at least a subset of bits in a repetition field in the DCI.

In an exemplary embodiment, the reserved state of the MCS field in the DCI for indicating the use of 16-QAM is represented by multiple bits in the MCS field in the DCI.

In an exemplary embodiment, in the case where the first indication indicates the In-band deployment, a first range of TBS indices spanning from 11 to 13 for 16-QAM in the In-band deployment is indicated in a modulation and coding scheme. MCS, field in DCI; and a second range of TBS indices spanning from 14 to 17 for 16-QAM in the In-band deployment is indicated in at least a subset of bits in a repetition field in the DCI.

In an exemplary embodiment, the use of 16-QAM is indicated in a single bit in the DCI.

In an exemplary embodiment, the first indication of said deployment mode, the second indication of the use of 16-QAM, and the third indication of the range of TBS indices for 16-QAM are transmitted to the UE in DCI.

In an exemplary embodiment, the Stand-alone or Guard-band deployment for 16-QAM is indicated in one of reserved states of a modulation and coding scheme, MCS, field in the DCI, the In-band deployment for 16-QAM is indicated in another of the reserved states of the MCS field in the DCI, and the range of TBS indices for 16-QAM is indicated in at least a subset of bits in a repetition field in the DCI.

In an exemplary embodiment, the reserved state of the MCS field in the DCI for indicating the Stand-alone or Guard-band deployment for 16-QAM, and the reserved state of the MCS field in the DCI for indicating the In-band deployment for 16-QAM are respectively represented by multiple bits in the MCS field in the DCI.

Hereinafter, a structure of a network node according to another exemplary embodiment of the present disclosure will be described with reference to FIG. 8. FIG. 8 schematically shows a block diagram of a network node 800 according to an exemplary embodiment of the present disclosure. The network node 800 in FIG. 8 may perform the methods 300 and 400 as described previously with reference to FIGS. 3 and 4, respectively. Accordingly, some detailed description on the network node 800 may refer to the corresponding description of the method 300 in FIG. 3 and the method 400 in FIG. 4, and thus will be omitted here for simplicity.

As shown in FIG. 8, the network node 800 includes at least one processor 801 and at least one memory 803. The at least one processor 801 includes e.g., any suitable CPU (Central Processing Unit), microcontroller. DSP (Digital Signal Processor), etc., capable of executing computer program instructions. The at least one memory 803 may be any combination of a RAM (Random Access Memory) and a ROM (Read Only Memory). The at least one memory 803 may also include persistent storage, which, for example, can be any single one or combination of magnetic memory, optical memory, or solid state memory or even remotely mounted memory.

The at least one memory 803 stores instructions executable by the at least one processor 801. The instructions, when loaded from the at least one memory 803 and executed on the at least one processor 801, may cause the network node 800 to perform the actions. e.g., of the procedures as described earlier respectively in conjunction with FIGS. 3 and 4, and thus will be omitted here for simplicity.

The present disclosure also provides at least one computer program product in the form of a non-volatile or volatile memory. e.g., a non-transitory computer readable storage medium, an Electrically Erasable Programmable Read-Only Memory (EEPROM), a flash memory and a hard drive. The computer program product includes a computer program.

The computer program includes: code/computer readable instructions, which when executed by the at least one processor 601 causes the UE 600 to perform the actions. e.g., of the procedures described earlier in conjunction with FIGS. 1 and 2; or code/computer readable instructions, which when executed by the at least one processor 801 causes the network node 800 to perform the actions. e.g., of the procedures described earlier respectively in conjunction with FIGS. 3 and 4.

The computer program product may be configured as a computer program code structured in computer program modules. The computer program modules could essentially perform the actions of the flow illustrated in any of FIGS. 1 to 4.

The processor may be a single CPU (Central processing unit), but could also include two or more processing units. For example, the processor may include general purpose microprocessors; instruction set processors and/or related chips sets and/or special purpose microprocessors such as Application Specific Integrated Circuit (ASICs). The processor may also include board memory for caching purposes. The computer program may be carried by a computer program product connected to the processor. The computer program product may include a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

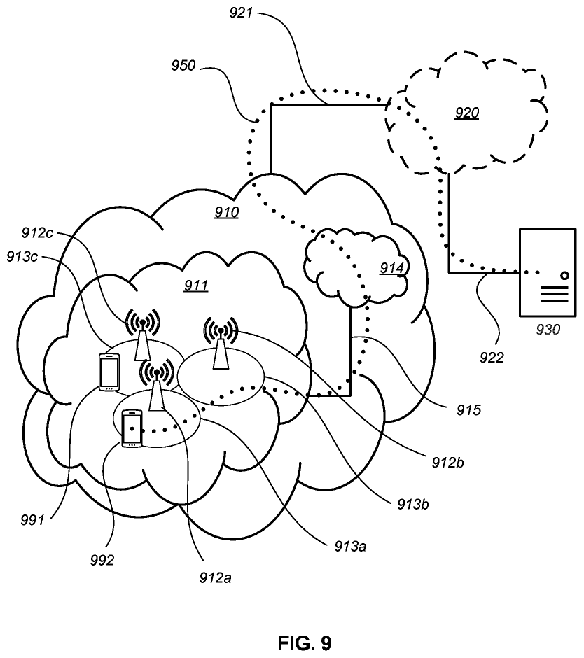

With reference to FIG. 9, in accordance with an embodiment, a communication system includes a telecommunication network 910, such as a 3GPP-type cellular network, which comprises an access network 911, such as a radio access network, and a core network 914. The access network 911 comprises a plurality of network nodes 912a. 912b, 912c, such as NBs. eNBs, gNBs or other types of wireless access points, each defining a corresponding coverage area 913a. 913b. 913c. Each network node 912a. 912b. 912c is connectable to the core network 914 over a wired or wireless connection 915. A first user equipment (UE) 991 located in coverage area 913c is configured to wirelessly connect to, or be paged by, the corresponding network node 912c. A second UE 992 in coverage area 913a is wirelessly connectable to the corresponding network node 912a. While a plurality of UEs 991, 992 are illustrated in this example, the disclosed embodiments are equally applicable to a situation where a sole UE is in the coverage area or where a sole UE is connecting to the corresponding network node 912.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. The connections 921, 922 between the telecommunication network 910 and the host computer 930 may extend directly from the core network 914 to the host computer 930 or may go via an optional intermediate network 920. The intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system of FIG. 9 as a whole enables connectivity between one of the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, a network node 912 may not or need not be informed about the past routing of an incoming downlink communication with data originating from a host computer 930 to be forwarded (e.g., handed over) to a connected UE 991. Similarly, the network node 912 need not be aware of the future routing of an outgoing uplink communication originating from the UE 991 towards the host computer 930.

The UE 992 is configured to include at least an interpretation unit (not shown) as previously described.

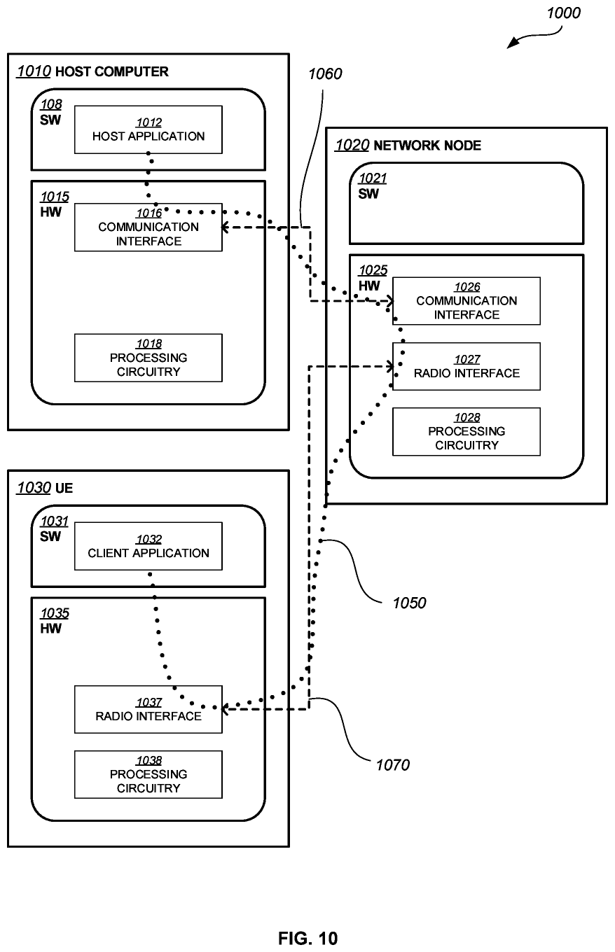

Example implementations, in accordance with an embodiment, of the UE, network node and host computer discussed in the preceding paragraphs will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 108, which is stored in or accessible by the host computer 1010 and executable by the processing circuitry 1018. The software 108 includes a host application 1012. The host application 1012 may be operable to provide a service to a remote user, such as a UE 1030 connecting via an OTT connection 1050 terminating at the UE 1030 and the host computer 1010. In providing the service to the remote user, the host application 1012 may provide user data which is transmitted using the OTT connection 1050.

The communication system 1000 further includes a network node 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with a UE 1030 located in a coverage area (not shown in FIG. 10) served by the network node 1020. The communication interface 1026 may be configured to facilitate a connection 1060 to the host computer 1010. The connection 1060 may be direct or it may pass through a core network (not shown in FIG. 10) of the telecommunication system and/or through one or more intermediate networks outside the telecommunication system. In the embodiment shown, the hardware 1025 of the network node 1020 further includes processing circuitry 1028, which may comprise one or more programmable processors, application-specific integrated circuits, field programmable gate arrays or combinations of these (not shown) adapted to execute instructions. The network node 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a network node serving a coverage area in which the UE 1030 is currently located. The hardware 1035 of the UE 1030 further includes processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, network node 1020 and UE 1030 illustrated in FIG. 10 may be identical to the host computer 1030, one of the network nodes 912a. 912b. 912c and one of the UEs 991, 992 of FIG. 9, respectively. This is to say, the inner workings of these entities may be as shown in FIG. 10 and independently, the surrounding network topology may be that of FIG. 9.

In FIG. 10, the OTT connection 1050 has been drawn abstractly to illustrate the communication between the host computer 1010 and the use equipment 1030 via the network node 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

The wireless connection 1070 between the UE 1030 and the network node 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may reduce PDCCH detection time and complexity and thereby provide benefits such as reduced user waiting time and reduced power consumption at the UE.

A measurement procedure may be provided for the purpose of monitoring data rate, latency and other factors on which the one or more embodiments improve. There may further be an optional network functionality for reconfiguring the OTT connection 1050 between the host computer 1010 and UE 1030, in response to variations in the measurement results. The measurement procedure and/or the network functionality for reconfiguring the OTT connection 1050 may be implemented in the software 108 of the host computer 1010 or in the software 1031 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which software 108, 1031 may compute or estimate the monitored quantities. The reconfiguring of the OTT connection 1050 may include message format, retransmission settings, preferred routing etc.; the reconfiguring need not affect the network node 1020, and it may be unknown or imperceptible to the network node 1020. Such procedures and functionalities may be known and practiced in the art. In certain embodiments, measurements may involve proprietary UE signaling facilitating the host computer's 1010 measurements of throughput, propagation times, latency and the like. The measurements may be implemented in that the software 108, 1031 causes messages to be transmitted, in particular empty or ‘dummy’ messages, using the OTT connection 1050 while it monitors propagation times, errors etc.

FIG. 11 is a flowchart illustrating a method 1100 implemented in a communication system, in accordance with one embodiment. The communication system includes a host computer, a network node and a UE which may be those described with reference to FIGS. 9 and 10. For simplicity of the present disclosure, only drawing references to FIG. 11 will be included in this section. In a first step 1110 of the method 1100, the host computer provides user data. In an optional substep 1111 of the first step 1110, the host computer provides the user data by executing a host application. In a second step 1120, the host computer initiates a transmission carrying the user data to the UE. In an optional third step 1130, the network node transmits to the UE the user data which was carried in the transmission that the host computer initiated, in accordance with the teachings of the embodiments described throughout this disclosure. In an optional fourth step 1140, the UE executes a client application associated with the host application executed by the host computer.

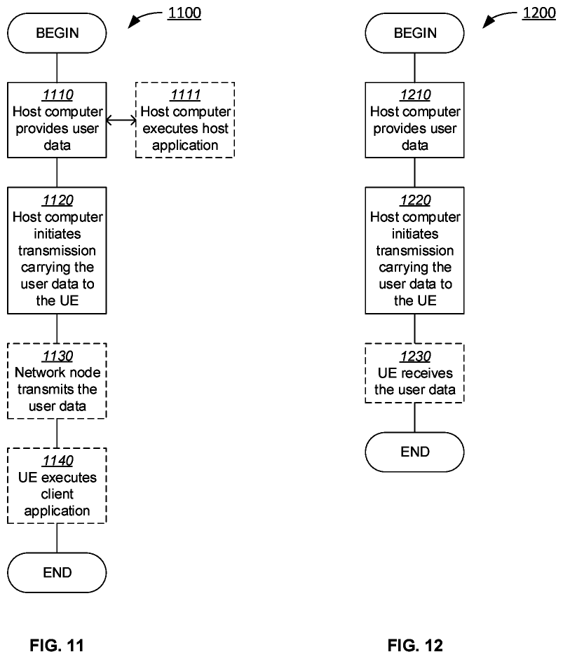

FIG. 12 is a flowchart illustrating a method 1200 implemented in a communication system, in accordance with one embodiment. The communication system includes a host computer, a network node and a UE which may be those described with reference to FIGS. 9 and 10. For simplicity of the present disclosure, only drawing references to FIG. 12 will be included in this section. In a first step 1210 of the method 1200, the host computer provides user data. In an optional substep (not shown) the host computer provides the user data by executing a host application. In a second step 1220, the host computer initiates a transmission carrying the user data to the UE. The transmission may pass via the network node, in accordance with the teachings of the embodiments described throughout this disclosure. In an optional third step 1230, the UE receives the user data carried in the transmission.

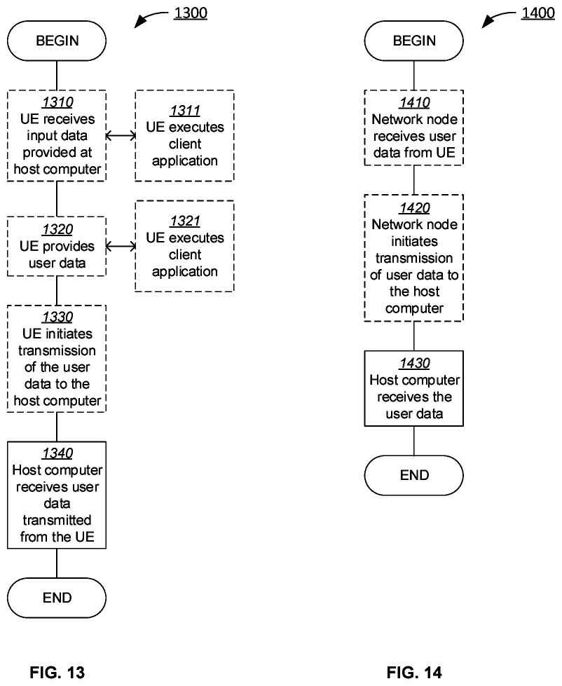

FIG. 13 is a flowchart illustrating a method 1300 implemented in a communication system, in accordance with one embodiment. The communication system includes a host computer, a network node and a UE which may be those described with reference to FIGS. 9 and 10. For simplicity of the present disclosure, only drawing references to FIG. 13 will be included in this section. In an optional first step 1310 of the method 1300, the UE receives input data provided by the host computer. Additionally or alternatively, in an optional second step 1320, the UE provides user data. In an optional substep 1321 of the second step 1320, the UE provides the user data by executing a client application. In a further optional substep 1311 of the first step 1310, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1330, transmission of the user data to the host computer. In a fourth step 1340 of the method 1300, the host computer receives the user data transmitted from the UE, in accordance with the teachings of the embodiments described throughout this disclosure.

FIG. 14 is a flowchart illustrating a method 1400 implemented in a communication system, in accordance with one embodiment. The communication system includes a host computer, a network node and a UE which may be those described with reference to FIGS. 9 and 10. For simplicity of the present disclosure, only drawing references to FIG. 14 will be included in this section. In an optional first step 1410 of the method 1400, in accordance with the teachings of the embodiments described throughout this disclosure, the network node receives user data from the UE. In an optional second step 1420, the network node initiates transmission of the received user data to the host computer. In a third step 1430, the host computer receives the user data carried in the transmission initiated by the network node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the present disclosure may take the form of a computer program product on a tangible computer usable storage medium having computer program code embodied in the medium that can be executed by a computer. Any suitable tangible computer readable medium may be utilized including hard disks. CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the present disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

1. A method at a user equipment, UE, comprising:
receiving, from a network node, information comprising:
a first indication of a deployment mode for communication,
a second indication of use of 16-quadrature amplitude modulation, 16-QAM, and
a third indication of a range of transport block size, TBS, indices for 16-QAM; and
interpreting, based on said deployment mode, the range of TBS indices for 16-QAM as a range of TBS indices for 16-QAM in said deployment mode,
wherein the first indication of said deployment mode is received from the network node in at least one of:
system information, or
UE specific configuration, and
wherein the second indication of the use of 16-QAM and the third indication of the range of TBS indices for 16-QAM are received from the network node in downlink control information, DCI.

2. The method of claim 1, wherein the deployment mode comprises one of:
a Stand-alone deployment,
a Guard-band deployment, and
an In-band deployment.

3. The method of claim 2, wherein said interpreting the range of TBS indices for 16-QAM further comprises:
in a case where the first indication indicates the Stand-alone or Guard-band deployment, interpreting the range of TBS indices for 16-QAM as a range of TBS indices spanning from 14 to 21 for 16-QAM in the Stand-alone or Guard-band deployment; and
in a case where the first indication indicates the In-band deployment, interpreting the range of TBS indices for 16-QAM as a range of TBS indices spanning from 11 to 17 for 16-QAM in the In-band deployment.

4. The method of claim 1, wherein the system information comprises:
MasterInformationBlock-Narrowband, MIB-NB, mapped to Narrowband Physical Broadcast Channel, NPBCH, for anchor carriers, or
SystemInformationBlockType22-NB-r14 for non-anchor carriers.

5. The method of claim 1, wherein the UE specific configuration comprises DL-CarrierConfigDedicated-NB for non-anchor carriers.

6. The method of claim 1, wherein
the use of 16-QAM is indicated in one of reserved states of a modulation and coding scheme, MCS, field in the DCI, and
the range of TBS indices for 16-QAM in said deployment mode is indicated in at least a subset of bits in a repetition field in the DCI.

7. The method of claim 6, wherein the reserved state of the MCS field in the DCI for indicating the use of 16-QAM is represented by multiple bits in the MCS field in the DCI.

8. The method of claim 3, wherein in the case where the first indication indicates the In-band deployment,
a first range of TBS indices spanning from 11 to 13 for 16-QAM in the In-band deployment is indicated in a modulation and coding scheme, MCS, field in DCI; and
a second range of TBS indices spanning from 14 to 17 for 16-QAM in the In-band deployment is indicated in at least a subset of bits in a repetition field in the DCI.

9. The method of claim 1, wherein
the use of 16-QAM is indicated in a single bit in the DCI.

10. A method at a network node, comprising:
transmitting, to a user equipment, UE, information comprising:
a first indication of a deployment mode for communication,
a second indication of use of 16-quadrature amplitude modulation, 16-QAM, and
a third indication of a range of transport block size, TBS, indices for 16-QAM,
wherein said deployment mode and the range of TBS indices for 16-QAM are used for indicating the UE to interpret the range of TBS indices for 16-QAM in said deployment mode,
wherein the first indication of said deployment mode is transmitted in at least one of:
system information, or
UE specific configuration, and
wherein the second indication of the use of 16-QAM and the third indication of the range of TBS indices for 16-QAM are transmitted to the UE in downlink control information, DCI.

11. The method of claim 10, wherein the deployment mode comprises one of:
a Stand-alone deployment,
a Guard-band deployment, and
an In-band deployment.

12. The method of claim 11, wherein
in a case where the first indication indicates the Stand-alone or Guard-band deployment, the Stand-alone or Guard-band deployment and the range of TBS indices for 16-QAM are used for indicating the UE to interpret a range of TBS indices spanning from 14 to 21 for 16-QAM in the Stand-alone or Guard-band deployment; and
in a case where the first indication indicates the In-band deployment, the In-band deployment and the range of TBS indices for 16-QAM are used for indicating the UE to interpret a range of TBS indices spanning from 11 to 17 for 16-QAM in the In-band deployment.

13. The method of claim 10, wherein the system information comprises:
MasterInformationBlock-Narrowband, MIB-NB, mapped to Narrowband Physical Broadcast Channel, NPBCH, for anchor carriers, or
SystemInformationBlockType22-NB-r14 for non-anchor carriers.

14. The method of claim 13, wherein the UE specific configuration comprises DL-CarrierConfigDedicated-NB for non-anchor carriers.

15. The method of claim 10, wherein
the use of 16-QAM is indicated in one of reserved states of a modulation and coding scheme, MCS, field in the DCI, and
the range of TBS indices for 16-QAM in said deployment mode is indicated in at least a subset of bits in a repetition field in the DCI.

16. The method of claim 15, wherein the reserved state of the MCS field in the DCI for indicating the use of 16-QAM is represented by multiple bits in the MCS field in the DCI.

17. The method of claim 12, wherein in the case where the first indication indicates the In-band deployment,
a first range of TBS indices spanning from 11 to 13 for 16-QAM in the In-band deployment is indicated in a modulation and coding scheme, MCS, field in DCI; and
a second range of TBS indices spanning from 14 to 17 for 16-QAM in the In-band deployment is indicated in at least a subset of bits in a repetition field in the DCI.

18. The method of claim 10, wherein
the use of 16-QAM is indicated in a single bit in the DCI.

19. A user equipment, UE, comprising:
at least one processor, and
at least one memory, storing instructions which, when executed on the at least one processor, cause the UE to:
receive, from a network node, information comprising:
a first indication of a deployment mode for communication,
a second indication of use of 16-quadrature amplitude modulation, 16-QAM,
a third indication of a range of transport block size, TBS, indices for 16-QAM; and
interpret, based on said deployment mode, the range of TBS indices for 16-QAM as a range of TBS indices for 16-QAM in said deployment mode,
wherein the first indication of said deployment mode is received from the network node in at least one of:
system information, or
UE specific configuration, and
wherein the second indication of the use of 16-QAM and the third indication of the range of TBS indices for 16-QAM are received from the network node in downlink control information, DCI.

20. (canceled)

21. A network node, comprising:
at least one processor, and
at least one memory, storing instructions which, when executed on the at least one processor, cause the network node to:
transmit, to a user equipment, UE, information comprising:
a first indication of a deployment mode for communication,
a second indication of use of 16-quadrature amplitude modulation, 16-QAM,
a third indication of a range of transport block size, TBS, indices for 16-QAM,
wherein said deployment mode and the range of TBS indices for 16-QAM are used for indicating the UE to interpret the range of TBS indices for 16-QAM in said deployment mode,
wherein the first indication of said deployment mode is transmitted in at least one of:
system information, or
UE specific configuration, and
wherein the second indication of the use of 16-QAM and the third indication of the range of TBS indices for 16-QAM are transmitted to the UE in downlink control information, DCI.

22. (canceled)

23. A non-transitory computer readable storage medium having computer program instructions stored thereon, the computer program instructions, when executed by at least one processor, causing the at least one processor to perform the method according to claim 1.

24. A non-transitory computer readable storage medium having computer program instructions stored thereon, the computer program instructions, when executed by at least one processor, causing the at least one processor to perform the method according to claim 9.
